(19) United States
(12) Patent Application Publication
(10) Pub. No.: US 2002/0116848 A1
(43) Pub. Date: Aug. 29, 2002

(54) Decorative mirror set

(76) Inventor: Chun-Horng Lin, Rowland Heights, CA (US)

Correspondence Address: BACON & THOMAS, PLLC, 625 Slaters Lane, 4th Floor, Alexandria, VA, 22314-1176, US

(21) Appl. No.: 09/793,629

(22) Filed: Feb. 27, 2001

(51) Int. Cl. G09F 19/00

(52) U.S. Cl. 40/406

(57) ABSTRACT

Dexterously and versatilely designed decorative mirror set has a reflector plate, a transparent plate, a liquid medium, a miniature water pump, a stairway, and a down light. With a combined function of these components, the image of a picture or photograph is improved to become more beautiful and appealing by means of the principle of optics.

### BACKGROUND OF THE INVENTION

1. Field of the Invention

The present invention relates to decorative mirror set, and more particularly, to decorative mirror set utilizing principle of light reflection and refraction to beautify picture or photo images and create interesting atmosphere in the room.

2. Description of the Prior Art

Normally, people like to fix their favorite or memorial pictures or photographs in tablets and set on the table or hang on the wall for appreciation from time to time. However, the present inventor always think it is rather monotonous and insensible to preserve those valuable articles as such, and there must be some improvements to be done.

Aiming at the above depicted problem, the present inventor has delved into this matter with profound study and repeated experiments that finally brings off the present invention.

### SUMMARY OF THE INVENTION

It is an object of the present invention to provide a decorative mirror set utilizing principle of light reflection/refraction to beautify images of pictures or photographs exhibited in the room with the result of creating appealing and interesting atmosphere therein.

It is another object of the present invention to provide a decorative mirror set having reserved spacing for accommodating miniature equipment such as: a water pump with dripping mouth, and a down light which help create snug and dreamy feelings in the room.

For achieving the above mentioned objects, the decorative mirror set of the present invention comprises a housing divided into two separate sections, a closed section containing a liquid medium, and an opened section located below the closed section. A transparent barrier plate is interposed between the two sections. A picture(photo) is set in the opened section beneath the barrier. A reflector is provided for reflecting the incident light ray from picture(photo) transmitting through the liquid medium. A miniature water pump is isolatedly confined in the rear part of the housing for pumping up the liquid medium stored in the closed section and dripping down by meandering along a stairway formed in the closed section.

### BRIEF DESCRIPTION OF THE DRAWINGS

The drawings disclose an illustrative embodiment of the present invention which serves to exemplify the various advantages and objects hereof, and are as follows:

FIG. 1 is a lateral cross sectional view of the present invention;

FIG. 2 is an illustrative drawing of adjustable anguler relationship between the surfaces of the transparent barrier and the reflector;

FIG. 3 is a perspective three dimensional view of the present invention

### DETAILED DESCRIPTION OF THE PREFERRED EMBODIMENT

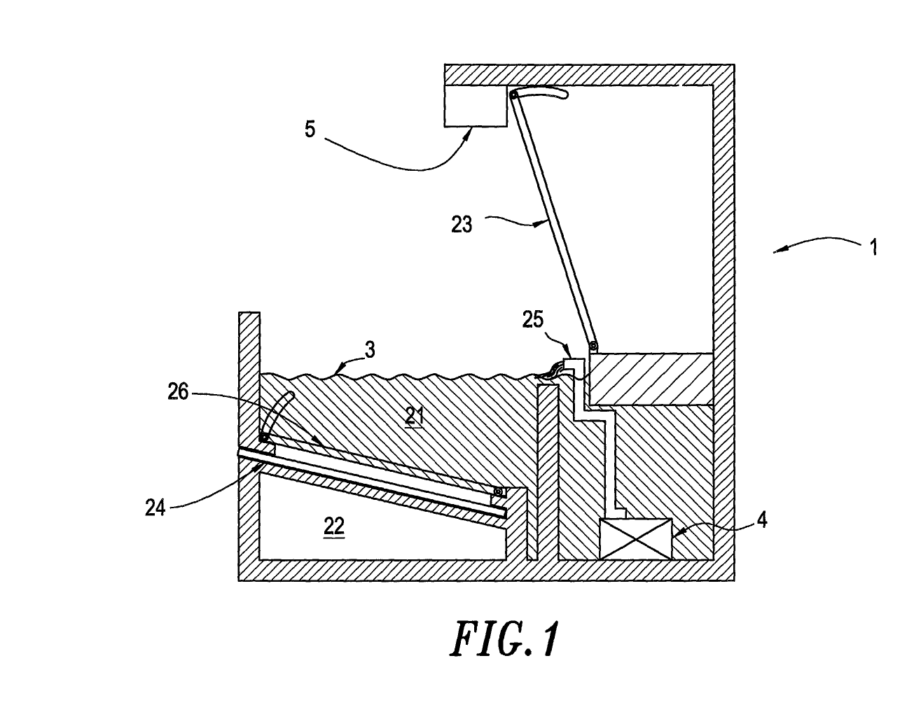

Referring to FIG. 1, the decorative mirror set 1 of the present invention comprises a housing 2 divided into two separate sections, a closed section 21 containing a liquid medium 3, and an opened section 22 located below the closed section 21. A transparent barrier plate 26 is interposed between the two sections 21 and 22. A picture (photo) 24 is set in the opened section 22 beneath the barrier plate 26. A reflector plate 23 is provided in standing pose for reflecting the incident light ray from the picture (photo) 24 transmitting with refraction through the liquid medium 3. A miniature water pump 4 is isolatedly confined in the rear part of the housing 2 for pumping up the liquid medium 3 stored in the closed section 21 and dripping down by meandering along a stairway 25 formed in the closed section 21.

With this structure, ripples are spread in rings on the surface of the liquid medium 3 caused by agitation arisen from continuous dripping of liquid medium 3 along the stairway 25. The rippling surface of the liquid medium 3 causes the refracted and reflected resultant image of picture (photo) 24 to form a foggy and vague appearance due to shaking thereby giving the observer a unique feeling. A lighting equipment 5, for example, a color varying down light can be employed to illuminate the picture (photo) 24 so as to exhibit pleasant lustrous effect.

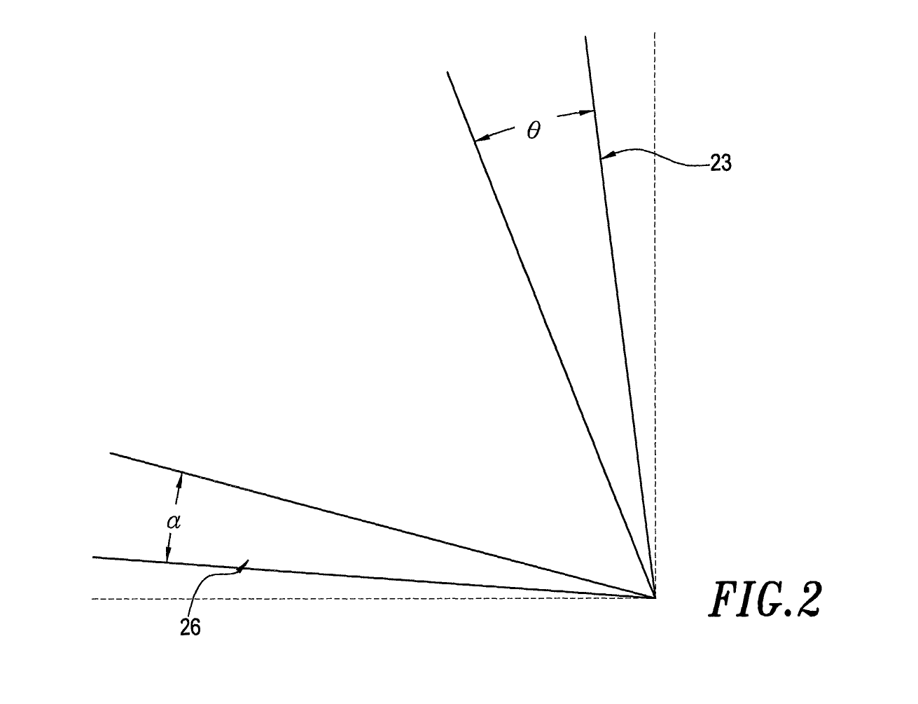

Referring to FIG. 2, both the reflector plate 23 and transparent barrier plate 26 are turnable with one end along respective guide ditches formed at the top end of the reflector plate 23 and the front end of the barrier plate 26 so that the tilted angles of the two surfaces are adjustable within a certain angle thereby achieving better observation angle for the image. According to a number of repeated experiments, the present inventor realized that the most preferable tilted angle θ for the surface of the reflector plate 23 is approximately 5° to 45° from vertical direction; while the most preferable tilted angle α for the surface of the transparent barrier plate 26 is approximately 5° to 45° from horizontal direction. Therefore, when the angle formed between the two surfaces of the reflector plate 23 and barrier plate 26 is 35° to 85°, the best observation effect can be expected. Of course this is not an absolute conclusion, the preferable angle for observation should be left to selection by the individual observer.

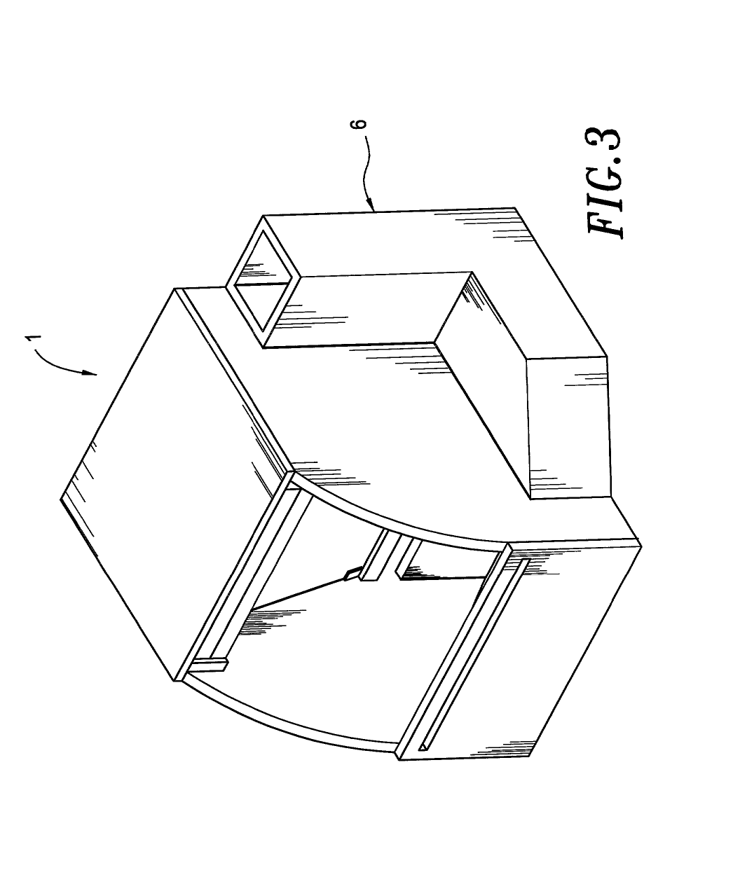

FIG. 3 is a perspective three dimensional view of the present invention, as shown in this drawing, an accommodation space 6 is further provided at one side of the mirror set 1 for allowing the user to exhibit his/her favorite ornamental articles therein thus further contributing to beautification of housing interior and upgrading quality of everyday life.

From the above description, it is understood that the dexterously designed present invention is not only decorative, but also educative for giving children an opportunity to practice the fundamental principle of optics. Besides, it is so simply constructed that it can be made with a low production cost.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. Decorative mirror set comprising:
a housing divided in two sections, a closed section containing a liquid medium therein, and an opened section located below said closed section,
a transparent barrier plate being interposed between said two sections, a picture (photo) being set in said opened section beneath said transparent barrier plate;
a reflector plate provided in standing pose in said housing for reflecting the incident light ray from said picture (photo) transmitting with refraction through said liquid medium: and
a miniature water pump isolatedly confined in the rear part of said housing for pumping up said liquid medium stored in said closed section and dripping down from a height into said closed section.

2. The decorative mirror set of claim 1, wherein a lighting equipment is provided at a relevant height in said housing for illuminating said picture (photo).

3. The decorative mirror set of claim 1, wherein a stairway is formed at an relevant position in said housing for said liquid medium pumped up by said miniature water pump to drip meandering down therealong.

4. The decorative mirror set of claim 1, wherein the most preferable tilted angle for the surface of said reflector plate is 5° to 45° from vertical direction.

5. The decorative mirror set of claim 1, wherein the most preferable tilted angle for the surface of said transparent barrier plate is 5° to 45° from horizontal direction.

6. The decorative mirror set of claim 1, wherein the best observation effect is achieved when the angle formed between the surfaces of said reflector plate and said barrier plate is from 35° to 85°.
